(19) United States
(12) Patent Application Publication
(10) Pub. No.: US 2014/0340868 A1
(43) Pub. Date: Nov. 20, 2014

(54) PLANAR SURGICAL LAMP

(71) Applicant: BenQ Medical Technology Corporation, Taipei (TW)

(72) Inventor: Chih Yuan WANG, Taoyuan City (TW)

(73) Assignee: BenQ Medical Technology Corporation, Taipei (TW)

(21) Appl. No.: 14/015,432

(22) Filed: Aug. 30, 2013

(30) Foreign Application Priority Data
May 14, 2013 (TW) 102208904

(51) Int. Cl. F21V 8/00

(52) U.S. Cl. CPC G02B 6/0011
USPC 362/33

(57) ABSTRACT

A planar surgical lamp includes a plurality of planar light source modules connected to form the planar surgical lamp. Each planar light source module includes a plurality of planar light source unit and each planar light source unit includes a light guide plate, which has a light incidence face and a light exit face; a light source, which generates light that enters the light guide plate via the light incidence face and projects out through the light exit face; a diffusion board, which is arranged at one side of the light exit face of the light guide plate; a surface panel, through which the light transmits; and a light guide sheet, which is arranged between the diffusion board and the surface panel. The disclosure divides a light source into a plurality of unit planar light sources so as to overcome the problems of the conventional surgical lamp of being bulky in size, great in weight, and subjected to constraints caused by laminar flows induced by the outer configuration of reflector.

### TECHNICAL FIELD

The disclosure relates to a surgical lamp, and relates to a planar surgical lamp.

### BACKGROUND

A conventional surgical lamp is often bulky and heavy and suffers laminar flows induced by the outside configuration of a reflector.

As shown in FIGS. 1 and 2, a conventional surgical lamp 1 comprises a reflector 2, a light source assembly 3, a handle 4, and a transparent board 5. The transparent board 5 is arranged on a rim of the reflector 2, whereby a space is formed between the reflector 2 and the transparent board 5 to receive the light source assembly 3 therein. The light source assembly 3 is set at the central site of the transparent board 5. The handle 4 is arranged under the light source assembly 3 in such a way that the handle 4 is operable to control upward and downward movement of the light source assembly 3. The handle 4 is provided with a protection tray 6 attached under the transparent board 5. The protection tray 6 receives circuit components mounted therein. The protection tray 6 is provided for mounting circuit components, such as electronic components, including circuit boards, integrated circuit chips, capacitors, and resistors in order to achieve various functions of fine adjustment of light and activation/de-activation of light.

The conventional surgical lamp is vital medical equipment, which provides lighting particularly in a surgical operation. The conventional surgical lamp concentrates light beams on a surgically operating site of a patient lying on an operation table to form field illumination for lighting.

### SUMMARY

A planar surgical lamp according to the disclosure comprises a plurality of planar light source modules that is connected to form the planar surgical lamp. Each of the planar light source modules comprises a plurality of planar light source units. Each of the planar light source units comprises a light guide plate, which has a light incidence face and a light exit face; a light source, which generates light that enters the light guide plate via the light incidence face and projects out through the light exit face; a diffusion board, which is arranged at one side of the light exit face of the light guide plate; a surface panel, through which the light transmits; and a light guide sheet, which is arranged between the diffusion board and the surface panel.

### BRIEF DESCRIPTION OF THE DRAWINGS

The disclosure will be apparent to those skilled in the art by reading the following description of preferred embodiments of the disclosure, with reference to the attached drawings, in which:

FIG. 1 is a schematic view showing a conventional surgical lamp;

FIG. 2 is a schematic view illustrating use of the conventional surgical lamp;

FIG. 3 is a schematic view showing a planar light source unit according to the disclosure;

FIG. 4 is a schematic view showing an LED light source according to the disclosure;

FIG. 5 is a schematic view showing a planar surgical lamp according to a first embodiment of the disclosure;

FIG. 6 is a schematic view showing a planar surgical lamp according to a second embodiment of the disclosure;

FIG. 7 is a schematic view showing a planar surgical lamp according to a third embodiment of the disclosure;

FIG. 8 is a schematic view showing a planar surgical lamp according to a fourth embodiment of the disclosure;

FIG. 9 is a schematic view showing a planar surgical lamp according to a fifth embodiment of the disclosure;

FIG. 10 is a schematic view showing a planar surgical lamp according to a sixth embodiment of the disclosure;

FIG. 11 is a schematic view showing a planar surgical lamp according to a seventh embodiment of the disclosure;

FIG. 12 is a schematic view showing a planar surgical lamp according to an eighth embodiment of the disclosure;

FIG. 13 is a schematic view showing a planar surgical lamp according to a ninth embodiment of the disclosure; and

FIG. 14 is a schematic view showing a planar surgical lamp according to a tenth embodiment of the disclosure.

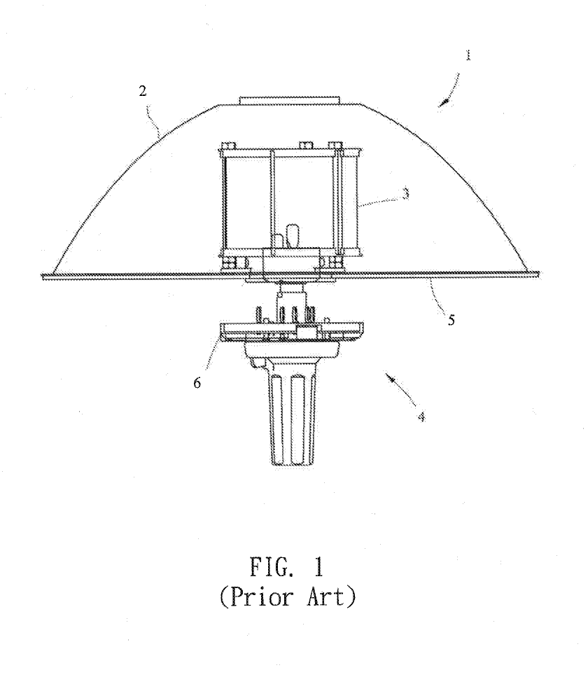

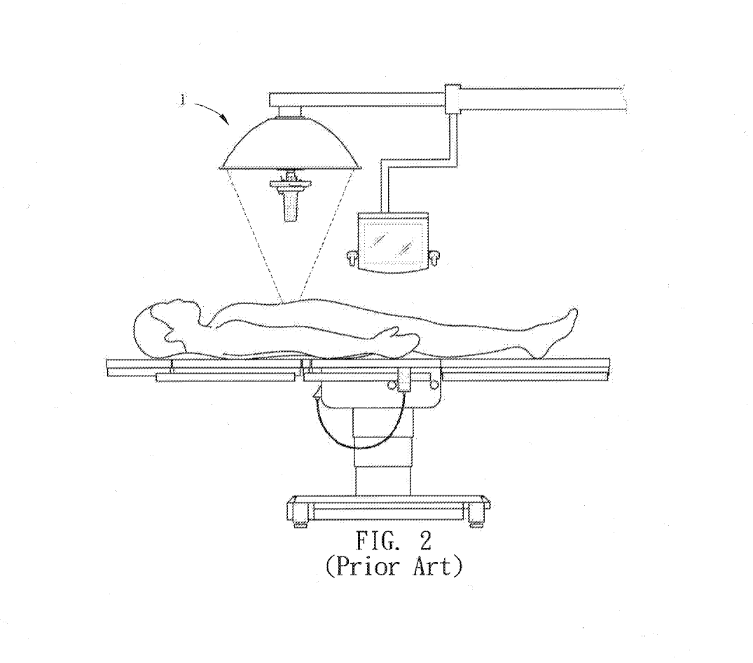

### DETAILED DESCRIPTION OF THE PREFERRED EMBODIMENTS

The object of the disclosure is to divide a light source into a plurality of unit planar light sources so as to overcome the problems of the conventional surgical lamp of being bulky in size, great in weight, and subjected to constraints caused by laminar flows induced by the outer configuration of reflector.

The disclosure uses a planar diffuser to change a light source into a light shape desired for surgical operation. Thus, the surgical lamp can be made so that the outside configuration is set in the form of a planar plate, the weight can be reduced, and the phenomenon of laminar flow is improved.

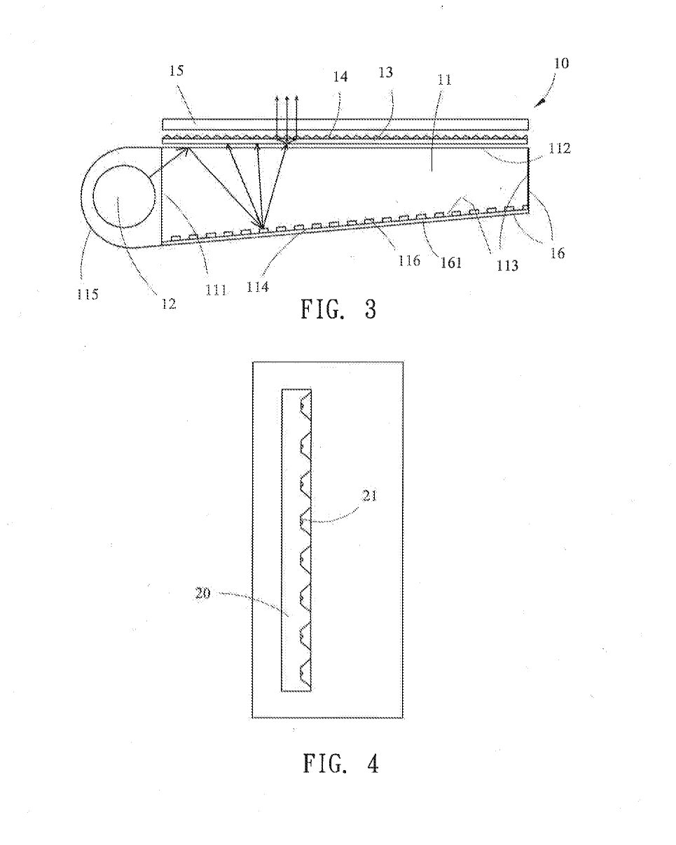

As shown in FIG. 3, a planar light source unit 10 comprises alight guide plate 11, a light source 12, a diffusion board 13, a light guide sheet 14, and a surface panel 15. The light source 12 emits light that passes through the light guide plate 11 to have the light reflected to the diffusion board 13 and the light guide sheet 14 and exiting from the surface panel 15. The light source 12 can be selectively an LED, an OLED, or a cold cathode fluorescent lamp. Arranged around the periphery of the light source 12 is a reflection member 115, which makes light entering the light guide plate 11. The light guide plate 11 comprises a light incidence face 111, a light exit face 112, and reflection faces 113. Light from the light source 12 transmits through the light incidence face 111 of the light guide plate 11 into the interior of the light guide plate 11. The reflection faces 16 of the light guide plate 11 have surfaces that are each coated with a reflection layer 161. Further, reflective dot patterns 114 are arranged in the light guide plate 11 at one side thereof. The reflective dot patterns 114 causes light entering the light incidence face 111 of the light guide plate 11 to be reflected to the light exit face 112, passing through the diffusion board 13, the light guide sheet 14, and the surface panel 15 to project out. The light guide sheet 14 comprises a plurality of prisms 141 for reflecting light.

As such, the planar light source unit 10 uses the light source 12 to transmit light into the light guide plate 11 and the light source 12 is constrained by the reflection member 115 to have the light completely transmitted into the light guide plate 11. The reflection faces 16 of the light guide plate 11 are respectively coated with reflection layers 161. The reflection layers 161 are generally applied to the reflection faces 113 that are neither a light incidence face nor a light exit face. The light guide plate 11 is provided therein, at one side thereof, with reflective dot patterns 114 that comprise prisms 116. The prisms 116 are located at one side of the reflection face 113 of the light guide plate 11, whereby light from the light source 12, after entering the light guide plate 11, is reflected by the prisms 116 to project out through the light exit face 112 of the light guide plate 11. A fraction of the light, which is not reflected by the prisms 116, is subjected to reflection within the light guide plate 11 by the reflection layer 161 to have the light projecting out through the light exit face 112. Once projecting out of the light guide plate 11, the light is diffused by the diffusion board 13 and guided by the light guide sheet 14 to form parallel light that emerges from the surface panel 15.

The light source 12 of the planar light source unit 10 according to the disclosure can be an LED (Light-Emitting Diode) light source, as shown in FIG. 4. The LED light source comprises a light source module, which gives off light. The LED light source comprises a plurality of LEDs 21 that is arranged in an array on a substrate 20 to form the light source module. The substrate 20 can be a circuit substrate and circuit wiring and electronic components are laid and mounted on the substrate 20. The LED light source is powered by a power supply and the LED light source can receive DC power or AC power that supplies power to the LED light source. The LED light source may give off white light, yellow light, blue light, or combinations thereof. White light is preferred for the surgical lamp.

The planar surgical lamp according to the disclosure is arranged in such a way that the planar light source unit 10 is taken as a basic unit and a plurality of planar light source units 10 is combined together to make a planar light source module 30. A plurality of planar light source modules 30 is combined and coupled together to form the planar surgical lamp according to the disclosure. Thus, the disclosure allows more diversified arrangements of the outside configuration than the conventional reflector-based surgical lamp and is not subjected to constraints caused by the reflector so that the disclosure may provide desired lighting and illumination for surgical operations.

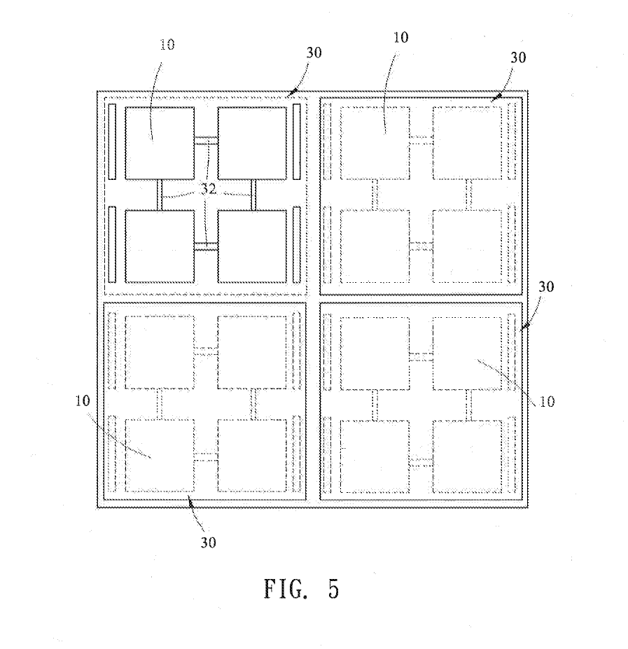

As shown in FIG. 5, the planar surgical lamp according to the disclosure comprises a hood 31 and planar light source modules 30. In an embodiment, the hood 31 receives four planar light source modules 30 mounted therein. For easy understanding of the disclosure, each of the planar light source modules 30 comprises a plurality of planar light source units 10. Each of the planar light source units 10 comprises a light guide plate 11 and a light source 12. A diffusion board 13, a light guide sheet 14, and a surface panel 15 are arranged outside a light exit face 112 of the light guide plate 11. In an embodiment, the light guide plate 11 and the light source 12 are integrated as a unitary planar light source unit 10.

The planar light source units 10 are connected to each other by connection members 32. The connection members 32 can be bolts and nuts or connection bars and any other mechanical structures that fall within the scope of the disclosure are enclosed in the scope of the disclosure. In an embodiment, four planar light source units 10 are connected to each other by the connection members 32 and the combination provides an area-expanded planar light source module 30 to form, in part, the planar surgical lamp.

Four of such area-expanded planar light source modules 30 are combined to form the planar surgical lamp that has an even larger area. In an embodiment of the disclosure, any desired planar surgical lamp can be made in such a way, as shown in FIG. 5.

Each planar light source unit 10 has a supply of power and comprises a controller and a circuit board (not shown) to control the operation of the planar light source unit 10.

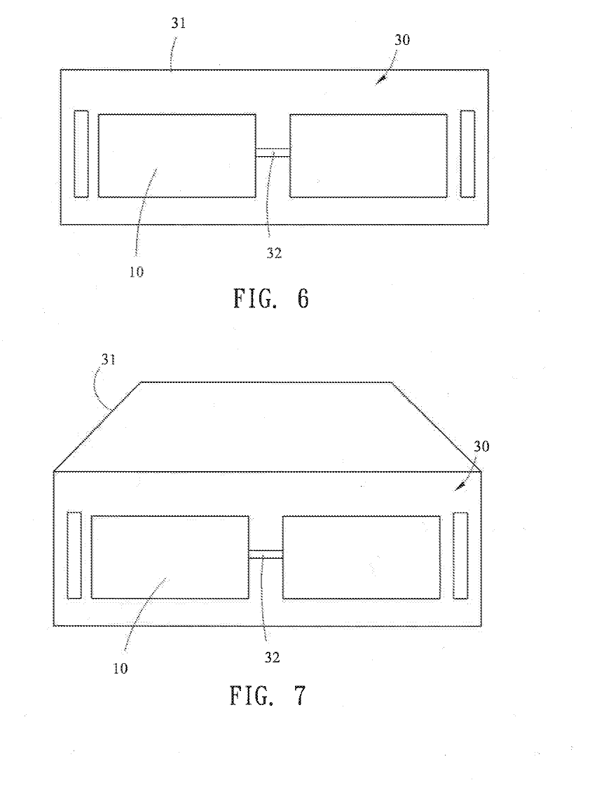

As shown in FIG. 6, at least one planar light source module 30 is arranged inside the hood 31 to allow the planar light source module 30 to be fixed in the hood 31. In an embodiment, the hood 31 has a rectangular shape.

As shown in FIG. 7, at least one planar light source module 30 is arranged inside the hood 31 to allow the planar light source module 30 to be fixed in the hood 31. In an embodiment, the hood 31 has a configuration that is a combination of a rectangle and a trapezoid that allows installation of other components/devices in an upper interior space of the hood 31.

As shown in FIGS. 5-7, the planar light source units 10 are connected to each other by the connection member(s) 32. The connection member 32 can be a rotatable joint member, such as a universal joint, so that each planar light source unit 10 can be individually rotated to achieve illumination at different directions. A complicated mechanism can be applied in an embodiment of the disclosure, such as a connection member 32 constructed with a combination of a spine and a stepping motor, to control the direction of illumination of the planar light source unit 10. Mechanisms that are applicable to moving the planar light source unit 10 in a similar way are all considered within the scope of the disclosure.

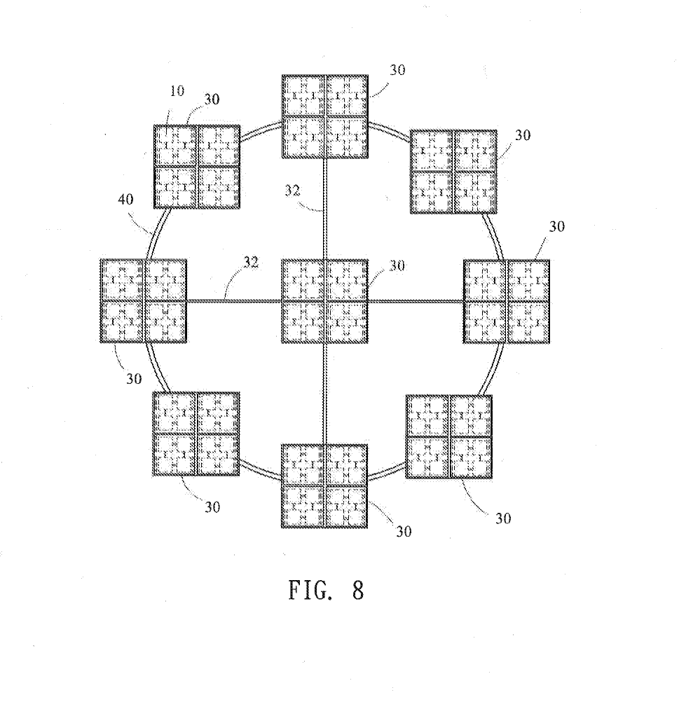

As shown in FIG. 8, to be consistent with the conventional configuration of the known surgical lamps, a plurality of planar light source modules 30 is arranged in an annular arrangement with an additional planar light source module 30 set at the center. The planar surgical lamp comprises a plurality of planar light source modules 30 and each of the planar light source modules 30 comprises at least one planar light source unit 10. Each planar light source module 30 is attached to an annular bar 40 in such a way that each planar light source module 30 is individually rotatable for adjusting the direction of illumination. For example, the planar light source modules 30 attached to the annular bar 40 can be adjusted set the illuminating direction of light inward so that the light concentrates in a desired field of illumination, namely the site where the operation is carried out. The central planar light source module 30 may constantly project light in a downward direction. Each planar light source module 30 can be adjusted individually or a number of the modules are adjusted together and the adjustment can be done manually or automatically. Automatic adjustment can be done by using mechanical components including stepping motors and gears, where the motors are arranged to simultaneously drive gears set at the back sides of the planar light source modules 30. In an embodiment, the gears are mounted to the back sides of the planar light source modules 30 and have bores fit over the annular bar, whereby the operation of the motors drives the gears to rotate the planar light source modules 30 (not illustrated). Whatever mechanisms can be used to rotate the planar light source modules 30 are considered within the scope of the disclosure.

The central planar light source module 30 can be connected, via connection member 32 to the peripheral planar light source module 30. Further, power lines can be laid through the annular bar 40 and the connection members 32 to electrically connect to each of the planar light source modules 30. As such, a planar light source module 30 can be constructed by combining a plurality of planar light source unit 10, which can be considered here the smallest unit, and a plurality of planar light source modules 30 is then combined and arranged in a predetermined geometric shape to form a surgical lamp, which realizes adjustability of angle and brightness.

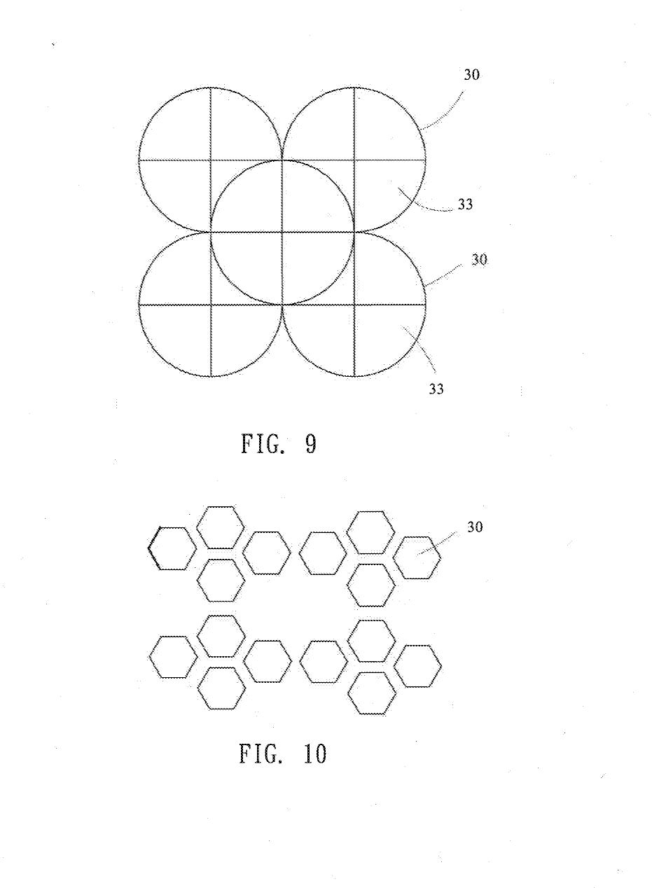

As shown in FIG. 9, the planar surgical lamp according to the disclosure can be of a circular configuration and a number of the planar light source modules 30 are arranged in a stacked form to provide desired illumination. In an embodiment, the circular planar light source module 30 can be divided into a number of fragments, such as four sectorial planar light source modules 33. The sectorial planar light source module 33 comprises a planar light source unit, and the planar light source unit can be of a sector form with a light source set at the conic apex. The light guide plate is of a sector form. Four sectorial planar light source modules 33 are then fixed to each other with fixing elements, such as steel frames and locking pieces (not shown).

With the four sectorial planar light source modules 33 combined to form a planar light source module 30 having a circular area, four such circular planar light source modules 30 are juxtaposed and connected to each other with connection members. Further, an additional planar light source module 30 having a circular area is set at the center to stack over the four planar light source modules 30 of circular area to form a surgical lamp.

As shown in FIG. 10, the planar light source module 30 is constructed as a hexagonal planar light source module 30. A plurality of hexagonal planar light source modules 30 are arranged to show a “tessellation” form that makes a surgical lamp.

As shown in FIG. 11, the planar light source module is constructed as a hexagonal planar light source module. A number of hexagonal planar light source modules are arranged in the pattern shown in FIG. 8 to make a surgical lamp.

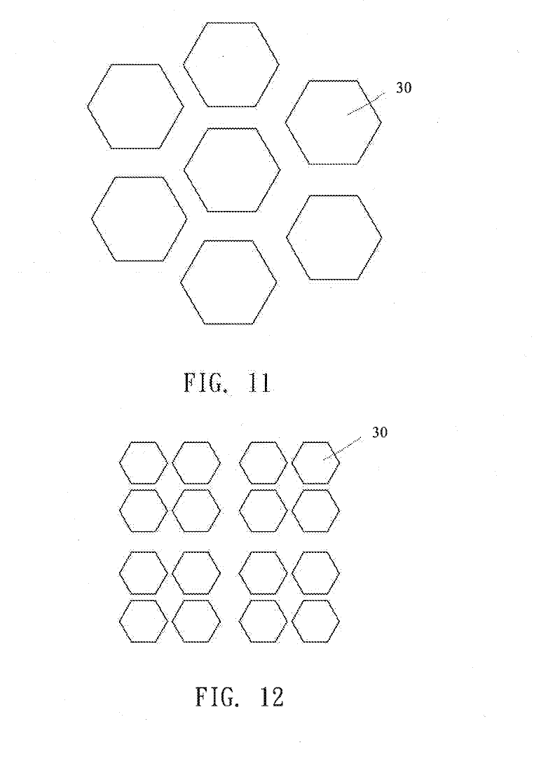

As shown in FIG. 12, the planar light source module 30 is constructed as a hexagonal planar light source module 30. A number of hexagonal planar light source modules 30 are arranged in an array to make a surgical lamp.

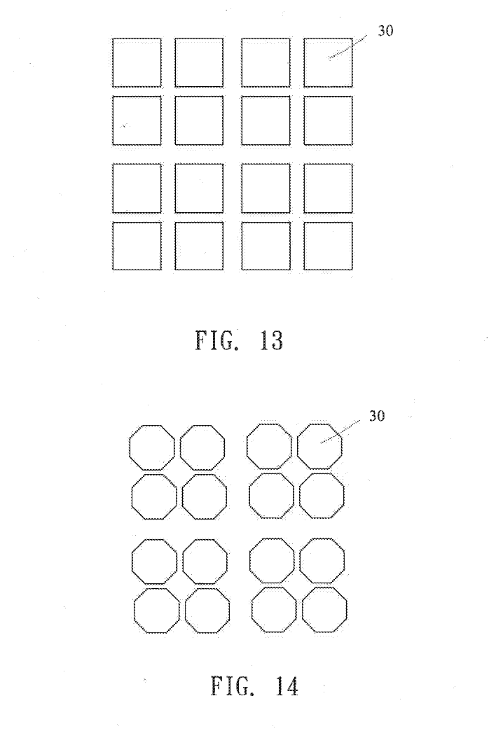

As shown in FIG. 13, the planar light source module 30 is constructed as a rectangular planar light source module 30. A number of rectangular planar light source modules 30 are arranged in an array to make a surgical lamp.

As shown in FIG. 14, the planar light source module 30 is constructed as an octagonal planar light source module 30. A number of octagonal planar light source modules 30 are arranged in an array to make a surgical lamp.

The disclosure uses a planar diffuser to change a light source to a light shape that is desired for a surgical operation. Thus, the surgical lamp can be made so that the outside configuration is set in the form of a planar plate, the weight can be reduced, and the phenomenon of laminar flow is improved.

Although the disclosure has been described with reference to the preferred embodiments thereof, it is apparent to those skilled in the art that a variety of modifications and changes may be made without departing from the scope of the disclosure which is intended to be defined by the appended claims.

What is claimed is:

1. A planar surgical lamp, comprising a plurality of planar light source modules connected to each other to form the planar surgical lamp, each of the planar light source modules comprising a plurality of planar light source units, each of the planar light source units comprising:
a light guide plate, which has a light incidence face and a light exit face;
a light source, which generates light that enters the light guide plate via the light incidence face and projects out through the light exit face;
a diffusion board, which is arranged at one side of the light exit face of the light guide plate;
a surface panel, through which the light transmits; and
a light guide sheet, which is arranged between the diffusion board and the surface panel.

2. The planar surgical lamp as claimed in claim 1, wherein the light source comprises LED, OLED, or cold cathode fluorescent lamp.

3. The planar surgical lamp as claimed in claim 1, wherein the light source is provided, along perimeter thereof, with a reflection member.

4. The planar surgical lamp as claimed in claim 1, wherein the light guide plate comprises a reflection face, the reflection face having a surface coated with a reflection layer, the light guide plate comprising a reflective dot pattern arranged therein at one side of the light exit face, the reflective dot pattern comprising a plurality of prisms.

5. The planar surgical lamp as claimed in claim 1, wherein the light guide sheet comprises a plurality of prisms for reflecting light.

6. The planar surgical lamp as claimed in claim 1, wherein the light source comprises an LED light source, which comprises a plurality of LEDs arranged in an array on a substrate to form a light source module, the substrate being a circuit substrate, on which metallic circuit wiring and electronic components are mounted.

7. The planar surgical lamp as claimed in claim 1, wherein the planar surgical lamp comprises a hood, in which at least one planar light source module is mounted.

8. The planar surgical lamp as claimed in claim 1, wherein the planar light source units are connected via connection member to each other.

9. The planar surgical lamp as claimed in claim 8, wherein the connection member comprises a universal joint.

10. The planar surgical lamp as claimed in claim 1, wherein the plurality of planar light source modules is arranged in an annular arrangement having a center at which an additional planar light source module is mounted, each of the planar light source modules being mounted to an annular bar.

11. The planar surgical lamp as claimed in claim 1, wherein the plurality of planar light source modules is arranged in a circular configuration, the plurality of planar light source modules being stacked to provide illumination.

12. The planar surgical lamp as claimed in claim 11, wherein each of the planar light source modules comprises a plurality of sectorial planar light source modules, each of which comprises a planar light source unit, a light source being set at a conic apex, the light guide plate being of a sector form, the four sectorial planar light source modules being fixed together with fixing elements.

13. The planar surgical lamp as claimed in claim 1, wherein each of the planar light source modules is a hexagonal planar light source module, the plurality of hexagonal planar light source modules being arranged in a tessellation form or in an array to make a surgical lamp.
